(19) United States
(12) Patent Application Publication
(10) Pub. No.: US 2016/0145720 A1
(43) Pub. Date: May 26, 2016

(54) High Strength Alpha/Near-alpha Ti Alloys

(71) Applicant: General Electric Company, (US)

(72) Inventors: Michael Francis Xavier Gigliotti, JR., Glenville, NY (US); Thomas Froats Broderick, Springboro, OH (US); Pazhayannur Ramanathan Subramanian, Niskayuna, NY (US); Andrew Philip Woodfield, Maineville, OH (US); Laura Cerully Dial, Clifton Park, NY (US)

(73) Assignee: GENERAL ELECTRIC COMPANY, Schenectady, NY (US)

(21) Appl. No.: 13/842,021

(22) Filed: Mar. 15, 2013

(51) Int. Cl. C22C 14/00; C04B 35/515

(52) U.S. Cl. CPC C22C 14/00; C04B 35/515

(57) ABSTRACT

Ta containing alpha/near alpha Ti alloys are disclosed. The alloys include Ta. The alloys retain higher percentage amounts of room temperature dynamic modulus at elevated temperatures.

### TECHNICAL FIELD

The present disclosure relates to high strength alpha and near-alpha Ti alloys.

### BACKGROUND

Titanium alloys typically exhibit a high strength-to-weight ratio, are corrosion resistant, and are resistant to creep at moderately high temperatures.

For these reasons, titanium alloys are used in aerospace, aeronautic, defense, marine, and automotive applications including, for example, jet engine components.

Ti alloys are attractive materials for aircraft applications because of their high strength-to-weight ratio. A common alpha/near-alpha Ti alloy that is used in a wide variety of applications is Ti811 (Ti-8 wt % Al.

Ti811 alloy is used in a number of applications that benefit from the alloy's advantageous combination of light weight, corrosion resistance, and high strength at low to moderate temperatures. For example, Ti811 alloy has been used in compressor blades in gas turbine engines where high temperature strength is required. Ti811 alloys, however, tend to lose strength and stiffness as measured by dynamic modulus at temperatures above about 800° F.

A need therefore exists for improved alpha/near-alpha Ti alloys which retain a greater percentage of their room temperature strength such as dynamic modulus at elevated temperatures.

### SUMMARY

The present disclosure relates generally to modified alpha/near-alpha Ti alloys such as Ta containing alpha/near-alpha Ti811 alloys. In a first aspect, the disclosure relates to Ta containing alpha/near-alpha Ti alloys such as Ta containing alpha/near-alpha Ti811 alloys. The alpha/near-alpha Ti alloy may include, in percent by weight based on total alloy weight: balance Ti; about 7 to about 9 Al; about 0.5 to about 11 Ta; about 0 to about 2 Cr, about 0 to about 5 Mo, and up to a total of 3 wt % of other alloying elements where the other alloying elements include one or more of Co, Cu, Fe, Mn, Ni, Si, Sn, V, and W and wherein the alloy is substantially free of Nb, Zr and Hf. Ta may be employed together with W where W is present in an amount of up to about 1 wt. %. The alpha/near-alpha Ti alloy may have an Al equivalent value of about 6.5 or more in and a dynamic modulus at 800° F. of about 15.5 MSI or more.

The Ta containing alpha/near-alpha alloy may be made into various articles of manufacture such as any one or more of an aircraft engine component, an aircraft structural component, an automotive component, a medical device component, sports equipment component, marine applications component, and chemical processing equipment component.

In other embodiments, the Ta containing alloy may include in percent by weight based on total alloy weight: about 7.8 Al; about 3.5 Ta; about 0.5 Cr; balance Ti, and wherein the alloy is substantially free of Nb, Zr and Hf. Also, in other embodiments, the Ta containing alloy may include in percent by weight based on total alloy weight: about 7.8 Al; about 3.5 Ta; about 1.0 Mo; balance Ti, and wherein the alloy is substantially free of Nb, Zr and Hf.

### BRIEF DESCRIPTION OF THE DRAWINGS

The features and advantages of alloys and related methods described herein may be better understood by reference to the accompanying drawing in which:

FIG. 1 is a plot of dynamic modulus of Ti811 and a Ta containing Ti-811 based alloy over the temperature range of about 75° F. to about 800° F.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms such as “about,” is not limited to the precise value specified. In some instances, the approximating language may correspond to the precision of an instrument for measuring the value. In some instances, the term “about” can denote a value within a range of ±10% of the quoted value.

### Definitions

As used herein alpha Ti refers to the low-temperature phase of titanium with an hexagonal close-packed (HCP) crystal structure; and beta Ti refers to the high-temperature phase of titanium with a body-centered cubic (bcc) crystal structure. Beta-stabilizers refer to those elements that stabilize the beta phase to lower temperatures; and alpha-stabilizers refer to those elements that stabilize alpha phase to higher temperatures. Alpha-stabilizers include Al and O; beta-stabilizers include most transition metals such as V, Cr, Fe, Co, Ni, and the refractory metals such as Nb, Mo, Ta, W.

As used herein, near-alpha Ti alloys are understood to mean titanium alloys in which the beta phase volume fraction is less than about 1 percent at room temperature. Near-alpha alloys typically have less than about 4 wt % beta-stabilizer. As used herein, the term aluminum-equivalent (Al_{eq}) refers to the sum of the alpha-stabilizers in an alloy where each element's amount is multiplied by a factor to yield a number representing the total strength of the alpha-stabilizers. Al equivalent value is Al_{eq} ≡wt. % Al+wt. % Zr/6+wt. % Sn/3+10·wt. % O, where wt. % is based on total weight of the alloy.

A single crystal of alpha Ti is non-isotropic, with its elastic modulus in the direction of hexagonal symmetry (c-axis direction) substantially higher than that in a direction orthogonal to that c-axis. For example, the modulus of Ti-64 is known to be 21.2×10⁶ psi parallel to c-axis and 16.0×10⁶ psi perpendicular to c-axis. As such, materials with large grains or materials that have been processed to have a non-random crystallographic orientation may exhibit an orientation dependence of elastic modulus. As used herein, the term “elastic modulus” or “modulus” is taken to mean Young's modulus: stress in a direction divided by linear strain in that direction. As used herein, elastic modulus refers to measurements made in randomly-oriented material, which is essentially isotropic.

### Materials

A wide variety of alpha/near-alpha Ti alloys may be employed and in modified as described below. Non limiting examples of alpha/near-alpha Ti alloys that may be employed include but are not limited to Ti811, Ti-(3-5)Al-2.5Sn; Ti-6A1-2Sn-4Zr-2Mo, Ti-1100(Ti-6A1-2.75Sn-4Zr-0.4Mo-0.45Si), IMI 679 (Ti-11Sn-5Zr-225Al-1Mo-0.25Si), IMI 685(Ti-6Al-5Zr-0.5Mo-0.25Si), IMI 829 (Ti-5Al-3.5Sn-3Zr-1Nb-0.3Si), IMI 834(Ti-5.8Al-4Sn-3.5Zr-0.7Nb-0.5Mo-0.35Si), VT4(Ti-4.6Al-1.5Mn), VT6(Ti-6Al-4V), VT18(Ti-6Al-1Mo-11Zr-1Nb), and VT20(Ti-6Al-1Mo-1V-2Zr).

These alpha/near-alpha Ti alloys according to the present disclosure include Ti, Al, Ta optionally with Cr or Mo. Also, any one or more of other alloying elements such as Co, Cu, Fe, Mn, Ni, Si, Sn, V and W may be employed with Ta. These other alloying elements may be employed in an amount up to about their room temperature solid solubility in alpha Ti. The alpha/near-alpha Ti alloys have an Al equivalent value (Al_{(eq)}) of about 6.5 or more, preferably about 6.5 to about 10, more preferably about 8 to about 9.5. Incidental impurities may be present in the Ta containing alpha/near-alpha Ti alloys according to the present disclosure. Typically, the modified alpha/near-alpha Ti alloys are free of Nb, Zr and Hf. However, Nb, Zr, and Hf may be present in an amount up to 0.1 percent by weight whereby the Ti alloys are understood to be substantially free of Nb, Zr and Hf. Ta may replace Nb on an atomic percent basis.

### Ti811 Containing Ta Composition

Ti811 alloy has, in terms of wt. %, 8Al, 1Mo, 90Ti and 1V. Ta containing Ti811 alpha/near-alpha alloys may include in percent by weight: about 7.5 to about 9.5 Al; about 0.5 to about 11 Ta; Cr in an amount of up to about 2, Mo in an amount of up to about 5, and other alloying elements such as but not limited to one or more of Co, Cu, Fe, Mn, Nb, Ni, Si, Sn, V, W and Y; balance Ti. These other alloying elements (Co, Cu, Fe, Mn, Ni, Si, Sn, V and W) may be employed in an amount up to about their room temperature solid solubility in alpha Ti. In certain embodiments, any one or more of V, Sn, Cr, Mo and W may be employed with Ta. Where V is employed with Ta, V may be present in an amount up to about 4 wt. %; where Mo is employed with Ta, Mo may be present in an amount of up to about 5 wt. %; where W is employed with Ta, W may be present in an amount of up to about 1 wt. % and where Sn is employed with Ta, Sn may be present in an amount of up to 2 wt. %. Where Y and lanthanides are employed with Ta, Sn may be present in an amount of less than about 1 wt. %. Where Cr is employed with Mo, Cr may be present in an amount of up to about 2 wt. %.

The alpha/near alpha Ta containing alloys such as those disclosed may be prepared by known melting procedures such as induction skull melting where components of the alloy are induction melted in a water-cooled copper crucible. The alloys also may be formed by other known melting procedures such as vacuum arc remelting together with thermomechanical processing, or by hearth melting together with thermomechanical processing.

In addition to the melting procedures as described above, the alloys may be made by direct electrochemical or chemical reduction of the compounds, salts or oxides of the alloy's constituent elements to powder as known in the art. This may yield a more homogenous alloy powder that may be used to produce alloys that have a finer grain size than conventional melting methods. The finer grain size alloys may be more readily inspected by ultrasound and may have improved forgeability. Chemical reduction procedures are detailed in U.S. Pat. Nos. 5,958,106; 6,712,952; 7,338,588; 6,737,017; 7,410,610 and 7,842,231 which are herein incorporated by reference.

Table 1 shows compositions and measured modulus of prior-art alloys based on Ti-811 in which Sn and Cr are added with a substantial absence of Ta. Dynamic modulus testing was performed following ASTM E1875-08, in which results are calculated assuming a Poisson's ratio of 0.3.

TABLE 1
Composition (wt. %) and modulus of
prior-art alloys based on Ti-811.

| | | | | | | | | Room | 800° F. |
|---|---|---|---|---|---|---|---|---|---|
| | | | | | | | | temp. | mod- |
| | | | | | | | | modulus | ulus |
| Alloy ID | Al | Cr | Mo | Sn | Ta | V | Ti | (Msi) | (Msi) |
| Ti-811 | 8.0 | — | 1.0 | — | — | 1.0 | Bal. | 18.4 | 15.4 |
| Ti-811 Sn 1 | 5.6 | — | 0.9 | 8.5 | — | 0.9 | Bal. | 17.2 | 14.5 |
| Ti-811 Sn 2 | 3.7 | — | 0.9 | 15.0 | — | 0.9 | Bal. | 15.8 | 13.6 |
| Ti-811-Cr | 8.0 | 0.5 | — | — | — | 1.0 | Bal. | 18.1 | 15.3 |

As shown in Table 1, alloys that contain Sn and Cr in the absence of Ta show a reduced dynamic modulus at 800° F.

Table 2 shows compositions and measured modulus of non-limiting embodiments of alpha/near-alpha Ta containing Ti alloys according to the present disclosure where all amounts are in wt. % based on total weight of the alloy. Dynamic modulus testing of alloy Ti-811-Ta was performed following ASTM E1875-08, in which results are calculated assuming a Poisson's ratio of 0.3. The dynamic modulus of Alloy Ti-811-Ta-Cr was tested at room temperature following ASTM STP 1045.

TABLE 2
Composition (wt %) and modulus Ta-containing
alpha/near-alpha Ti alloys.

| | | | | | | | | Room | 800° F. |
|---|---|---|---|---|---|---|---|---|---|
| | | | | | | | | temp. | mod- |
| | | | | | | | | modulus | ulus |
| Alloy ID | Al | Cr | Mo | Sn | Ta | V | Ti | (Msi) | (Msi) |
| Ti-811-Ta—Cr | 7.8 | 0.5 | — | — | 3.5 | — | Bal. | 18.4 | — |
| Ti-811-Ta | 7.8 | — | 1.0 | — | 3.5 | — | Bal. | 18.4 | 16.4 |

As shown in Table 2, in certain embodiments the Ta containing alpha/near-alpha Ti alloy may have, in percent by weight based on total alloy weight, about 7.8 Al; about 3.5 Ta; about 0.5 Cr; remainder Ti. The alloy may be substantially free of Nb, Zr and Hf. In other embodiments, the Ta containing alpha/near-alpha Ti alloy may have, in percent by weight based on total alloy weight: about 7.8 Al; about 3.5 Ta; about 1.0 Mo; remainder Ti. The alloy may be substantially free of Nb, Zr and Hf.

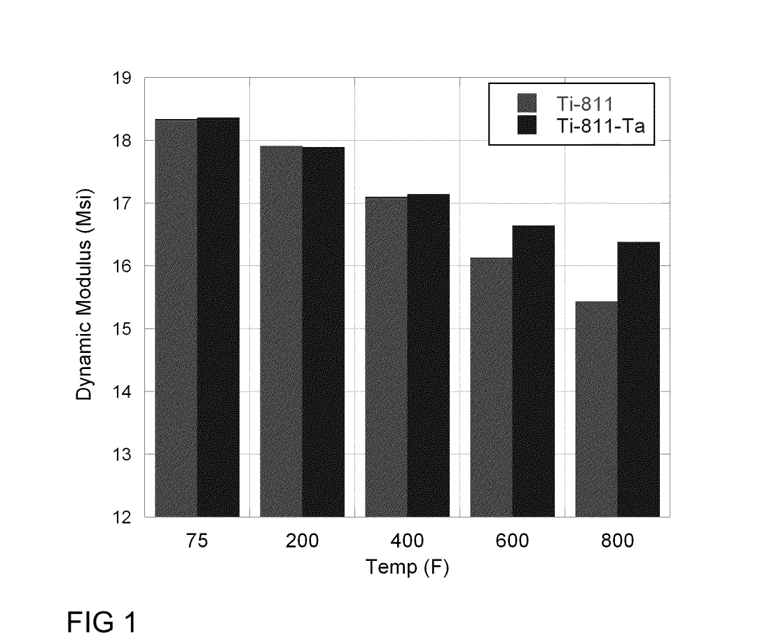

Addition of Ta to alpha and/near-alpha Ti base alloys such as Ti-811 alloy in may yield alpha/near-alpha Ti alloys that retain higher percentage amounts of room temperature dynamic modulus at elevated temperatures. The effect of addition of Ta to Ti-811 base alloy on dynamic modulus at temperature of up to about 800° F. is shown in Table 2 and FIG. 1.

The alpha/near-alpha alloys disclosed have superior dynamic moduli over prior art alloys at 800° F. Therefore, it is possible to produce articles formed of alloys according to the present disclosure for improved performance airfoils in aerospace, aeronautic, marine, automotive, and other turbine applications. In addition, the alloys of this disclosure may be used as the matrix in composites reinforced by ceramics such as SiC, Si₃N₄ and TiB₂.

1. An alpha/near-alpha Ti alloy comprising, in percent by weight based on total alloy weight: about 7 to about 9 Al; about 0.5 to about 11 Ta; about 0 to about 2 Cr, about 0 to about 5 Mo and up to 3 wt % of other alloying elements where the other alloying elements include one or more of Co, Cu, Fe, Mn, Ni, Si, Sn, V, W and Y and wherein the alloy is substantially free of Nb, Zr and Hf.

2. The alpha/near-alpha Ti alloy of claim 1, wherein the alloy comprises an Al equivalent value of at about 6.5 or more and exhibits a dynamic modulus at 800° F. of about 15.5 MSI or more.

3. The alpha/near alpha Ti alloy of claim 1, wherein the alloy comprises an Al equivalent value of about 8 to about 9.5, and exhibits a dynamic modulus of about 15.5 MSI or more at 800° F.

4. An article of manufacture comprising the alloy of claim 1.

5. The article of manufacture of claim 4, wherein the article of manufacture is any of an aircraft engine component, an aircraft structural component, an automotive component, a medical device component, a sports equipment component, a marine applications component, and a chemical processing equipment component.

6. An alpha/near-alpha Ti alloy comprising, in percent by weight based on total alloy weight: about 7.8 Al; about 3.5 Ta; about 0.5 Cr; remainder Ti and wherein the alloy is substantially free of Nb, Zr, and Hf.

7. An alpha/near-alpha Ti alloy comprising, in percent by weight based on total alloy weight: about 7.8 Al; about 3.5 Ta; about 1.0 Mo; remainder Ti and wherein the alloy is substantially free of Nb, Zr, and Hf.

8. A composite comprising the alloy of claim 1 and a ceramic reinforcement.

9. The alpha/near-alpha Ti alloy of claim 1 wherein the alloy is the product of a thermomechanically worked solidification product of a melt of constituent elements of the alloy.

10. The alpha/near-alpha Ti alloy of claim 1 wherein the alloy is formed by thermomechanically working a powder of the alloy formed by direct chemical reduction of compounds of alloy constituent elements.

11. The alpha/near-alpha Ti alloy of claim 10 wherein the compounds comprise one or more of salts and oxides of the alloy's constituent elements.

12. An article of manufacture comprising the composite of claim 8.

13. The article of manufacture of claim 12, wherein the article of manufacture is any of an aircraft engine component, an aircraft structural component, an automotive component, a medical device component, a sports equipment component, a marine applications component, and a chemical processing equipment component.

14. The article of manufacture of claim 12, wherein the alloy comprises an Al equivalent value of at about 6.5 or more and exhibits a dynamic modulus at 800° F. of about 15.5 MSI or more.

15. The article of manufacture of claim 12, wherein the alloy comprises an Al equivalent value of about 8 to about 9.5, and exhibits a dynamic modulus of about 15.5 MSI or more at 800° F.

16. The article of manufacture of claim 12, wherein the alloy is the product of a thermomechanically worked solidification product of a melt of constituent elements of the alloy.

17. The article of manufacture of claim 12, wherein the alloy is formed by thermomechanically working a powder of the alloy formed by direct chemical reduction of compounds of alloy constituent elements.

18. The article of manufacture of claim 17, wherein the compounds comprise one or more of salts and oxides of the alloy's constituent elements.
